(19) United States
(12) Patent Application Publication
(10) Pub. No.: US 2004/0094507 A1
(43) Pub. Date: May 20, 2004

(54) Stripping cross-linked photoresists

(76) Inventors: Michael D. Goodner, Hillsboro, OR (US); Kevin J. Lee, Beaverton, OR (US); Robert P. Meagley, Hillsboro, OR (US)

Correspondence Address: Timothy N. Trop, TROP, PRUNER & HU, P.C., 8554 KATY FWY, STE 100, HOUSTON, TX, 77024-1841, US

(21) Appl. No.: 10/294,207

(22) Filed: Nov. 14, 2002

(51) Int. Cl. C23F 1/00; B44C 1/22

(52) U.S. Cl. 216/41

(57) ABSTRACT

A cross-linked photoresist may be stripped without using water to reduce substrate corrosion. In one embodiment, a transesterification reaction may use an alcohol instead of water as the co-solvent for an organic base.

### BACKGROUND

This invention relates generally to processes for manufacturing semiconductor integrated circuits.

Photoresists may be utilized to transfer patterns from a mask to a semiconductor substrate. Many negative tone photoresists are cross-linked and thereby rendered insoluble upon exposure to radiation.

After the photoresist has been used successfully, the photoresist must be stripped from the semiconductor surface. Because the photoresist is cross-linked, it is essentially one entire molecule and cannot be dissolved. Instead, the photoresist must be chemically attacked to allow dissolution and to prevent filter clogs and resist residue defects that occur due to undissolved resist depositing on the wafer or process equipment surfaces.

The standard method for chemically attacking a cross-linked resist is using base-catalyzed ester hydrolysis. However, water is used in this type of reaction and water promotes copper corrosion.

Thus, there is a need for better ways to remove photoresist in the presence of corrosion-prone substrates such as copper and other metals.

### BRIEF DESCRIPTION OF THE DRAWINGS

FIG. 1 is a depiction of a chemical reaction according to one embodiment of the present invention;

FIG. 2 is a depiction of a chemical reaction according to one embodiment of the present invention; and

FIG. 3 is a depiction of a chemical reaction according to one embodiment of the present invention.

### DETAILED DESCRIPTION

A chemically cross-linked negative tone photoresist may be chemically attacked to promote dissolution without using water. For example, in one embodiment, base-catalyzed transesterification may be utilized. In this reaction, proton exchange is implemented between an alcohol, (ROH) having a functional group R, and a hydroxide anion, from ammonium hydroxide for example, to form water and the RO— anion:

ROH+OH⁻⇄HOH+RO⁻

Because the water in the above proton exchange reaction is an intermediate in equilibrium with other reagents, it will necessarily be present only in small concentrations, thereby not causing a significant amount of substrate corrosion.

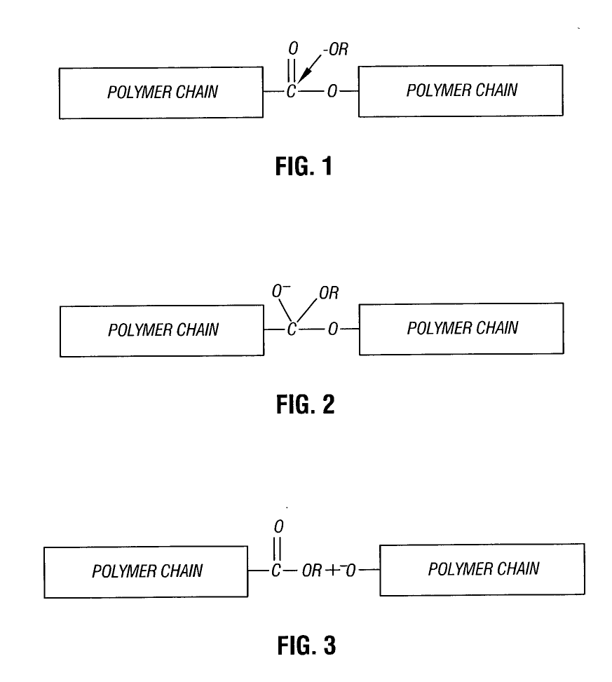

In the transesterification reaction (FIGS. 1 through 3), the ethereal side of the polymeric ester (the right polymer chain portion in FIG. 1) is exchanged for the alcohol's functional group R. Specifically, the alkoxide (RO—) from the proton exchange attacks the polymerized photoresist at the carbon oxygen double bond as shown in FIGS. 1 and 2. As a result, the polymer may be broken at the C—O double bond, forming a polymer alkoxide, as shown in FIG. 3, and a new ester having the functional group R. As a result, alcohols may be used instead of water as the co-solvent for the organic base, reducing the problem of copper corrosion.

The polymer alkoxide can then undergo proton exchange again to form a polymer with a terminal hydroxyl group, regenerating a hydroxide anion (when proton exchange occurs with water) or an alkoxide anion (when proton exchange occurs with alcohol).

In accordance with one embodiment of the present invention, a solvent, a solubility promoter, an organic base, and a co-solvent for the organic base may be utilized as a stripping solution. In one embodiment, the solvent can be N-methyl pyrrolidone (NMP), but other solvents may be also utilized. The solubility promoter may be diethanolamine (DEA), but other solubility promoters may also be utilized. In one embodiment the organic base may be tetramethyl ammonium hydroxide (TMAH), but other bases may be utilized including quaternary ammonium hydroxides, such as tetrabutyl ammonium hydroxide. In some embodiments, base and alcohol concentrations may be proportional to one another. For example, the concentration of the alcohol may be three times the concentration of the base. The co-solvent for the organic base may be methanol, but other alcohols may be used as well.

In one embodiment, greater than 50 percent by weight NMP may be used with 0.1 to 50 percent by weight DEA and 0.1 to 25 percent by weight TMAH. Methanol may be 0.1 to 50 weight percent of the stripping solution. The stripping solution may be applied at 28° C. for approximately ten minutes in one embodiment of the present invention, although stripping temperatures ranging from room temperature to just below the flash point of the solution are acceptable, and stripping times may range from five minutes to one hour.

Thus, in some embodiments of the present invention, the water content in the photoresist stripper may be reduced to reduce copper erosion. Replacing water in the stripper formulation with an alcohol allows alternative industrial sources of quaternary ammonium hydroxides to be used. Transforming the stripping mechanism from base-catalyzed hydrolysis to base-catalyzed transesterification may achieve these results in some embodiments. In some embodiments, the process window may be improved, removing the need to carefully remove the photoresist without corroding copper or any other corrosion-prone substrates that may be present. The chemical cross-linkers in the photoresist are susceptible to attack by transesterification, making the resist soluble in the carrier solvent, while decreasing substrate corrosion.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
forming a cross-linked photoresist; and
removing said photoresist without using water.

2. The method of claim 1 including removing said photoresist using transesterification.

3. The method of claim 1 including using an alcohol to remove said photoresist.

4. The method of claim 3 including causing proton exchange to occur between the alcohol and an hydroxide anion.

5. The method of claim 4 including exposing a cross-linker of said cross-linked photoresist to said anion.

6. The method of claim 5 including forming a hydroxide with the polymerized photoresist and regenerating an hydroxide anion.

7. The method of claim 3 including replacing a polymer functional group in said photoresist with a functional group from said alcohol.

8. A cross-linked photoresist stripping solution comprising:
an organic base; and
a co-solvent for said organic base including an alcohol.

9. The solution of claim 8 wherein said alcohol is an alkyl alcohol.

10. The solution of claim 8 wherein said alcohol is an aromatic alcohol.

11. The solution of claim 8 wherein said alcohol is methanol.

12. The solution of claim 8 wherein said organic base is a quaternary ammonium hydroxide.

13. The solution of claim 12 wherein said base is tetramethyl ammonium hydroxide.

14. The solution of claim 8 including a solvent and a solubility promoter.

15. A method comprising:
exposing a cross-linked photoresist to alcohol; and
removing said photoresist using transesterification.

16. The method of claim 1 including removing said photoresist without using water.

17. The method of claim 1 including using an organic base to attack said cross-linked photoresist.

18. The method of claim 17 including causing a proton exchange to occur between the alcohol and an hydroxide anion from said organic base.

19. The method of claim 18 including exposing a cross-linker of said cross-linked photoresist to said anion.

20. The method of claim 19 including forming a hydroxide with the polymerized photoresist and regenerating a hydroxide anion.

21. The method of claim 14 including replacing a polymer functional group in said photoresist with a functional group from said alcohol.

22. The method of claim 14 including using methanol as said alcohol.
